(19) United States
(12) Patent Application Publication
(10) Pub. No.: US 2012/0221967 A1
(43) Pub. Date: Aug. 30, 2012

(54) DASHBOARD OBJECT VALIDATION

(76) Inventor: Sabrina Kwan, San Diego, CA (US)

(21) Appl. No.: 13/035,680

(22) Filed: Feb. 25, 2011

(51) Int. Cl. G06F 3/048

(52) U.S. Cl. 715/763

(57) ABSTRACT

A method for validating an object with data can include obtaining a dashboard interface object. The dashboard interface object can include dashboard object data. Data can be stored on an information server and can be an intended basis for the dashboard object data. The stored data can be compared with the dashboard object data. The dashboard interface object can be validated when the dashboard object data is a desired result from the stored data based on the comparison.

### BACKGROUND

Business enterprises and others often use IT (Information Technology) Service Management (ITSM) technology to manage IT services. An example of an IT service is a Financial Planning and Analysis (FPA) service which can provide out-of-the-box tools for consolidating budgets and costs from various parts of the organization. FPA can also include out-of-the-box web-browser based dashboards for managers to view summary information in a timely manner to take actionable steps to optimize IT costs. FPA is provided as one example of an IT service, but other various IT service offerings, such as BusinessObjects Dashboard Builder, Starfish Dashboard, and others, are also available which can likewise provide summary information through dashboards for use by managers in managing the IT service offerings.

Business enterprises may wish to provide quality assurance (QA) for systematic monitoring and evaluation of the ITSM technology, and more specifically of the dashboards. Testing and validating dashboard pages that contain summaries graphics and gauges in a portal-like pages for highlighting important information can be a challenging task for a QA manager or team. Often, testing and validation of dashboard objects is performed manually by executing a sequence of database queries, and substituting parameters using the results from previous runs before calculating the expected results that are displayed on the dashboards. The process can be expensive, time-consuming and error-prone.

### BRIEF DESCRIPTION OF THE DRAWINGS

FIG. 1 is a screenshot of a dashboard interface object in accordance with an example of the present technology;

FIG. 2 is a block diagram of a test assist framework in accordance with an example of the present technology;

FIG. 3 is a flow diagram of a method for validating a dashboard interface object with stored data in accordance with an example of the present technology;

FIG. 4 is a flow diagram of a method for validating an object with data in accordance with an example of the present technology;

FIG. 5 is a block diagram of a system for validating a dashboard interface object with data in accordance with an example of the present technology; and

FIG. 6 is a block diagram of a system for prioritizing data backup requests in accordance with an example of the present technology.

### DETAILED DESCRIPTION

Reference will now be made to the examples illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

Testing and validating dashboards, or web pages that contain user interface controls or dashboard objects can be a challenging task for a QA manager or team. “Dashboard objects”, as referenced to herein, refers to graphics, gauges, charts, maps, dials, interfaces, displays, and other similar objects useful for graphically displaying and/or highlighting important information. Specifically, the dashboard objects can be configured to graphically display a representation of data or a desired manipulation of data from a data source. “Testing” and/or “validating” dashboard objects refers to a quality control process of ensuring that the graphical dashboard object is accurate, at least within a predetermined acceptable range of error.

A test assist framework in accordance with an embodiment of the technology can enable a QA engineer to use a simple command to generate reports on the fly that can be compared to web-based dashboard reports. In another example, reports can be generated with the comparison of displayed dashboard data to stored data. Enabling a QA engineer to avoid at least some of the manual and time-consuming testing and validation processes of prior systems can result in an improved product quality as well as an accelerated product development cycle.

The test assist framework can include tools that allow easy development of QA test scripts in parallel with the product development life cycles. The framework can include one or more web applications that can be used by the test scripts to automate the execution of test queries with dynamic parameters, calculate the expected test results, and generate instant reports.

In a specific example, the dashboard test scripts can be invoked by a test script. The data objects constructed by the test scripts can be used in a checkpoint or breakpoint of a recorded test to validate properties of a User Interface (UI) or graphical objects (e.g., dashboard objects). Validation reports can be accessed locally or via a web browser anywhere by a plurality of users. The framework can enable validation of multiple different dashboard objects in an automated fashion.

QuickTest Professional (QTP) is one example of a testing system which can enable automated testing for various software applications and environments. For example, QTP can perform functional and regression testing through a UI. QTP can identify objects in an application UI or a web page and perform desired operations. Some example operations include mouse clicks, keyboard events, etc. QTP can also capture object properties, such as object names and object handler identifications. QTP can use a VBScript (Visual Basic Scripting Edition) scripting language to specify a test procedure and to manipulate objects and controls of the application under test. More sophisticated actions can be performed by manipulating the underlying VBScript. QTP can be used for test case automation of both UI based and non-UI based cases. Non-UI based test cases can include file system operations and database testing, for example.

Though reference is made to QTP scripts and breakpoints, systems and methods can be developed which utilize other types of scripts and breakpoints/checkpoints as well. Thus, although at least some of the discussion of the technology uses examples referring to QTP, these examples are intended to be non-limiting and are provided for simplicity of demonstration and explanation of the technology. Other systems and methods for testing software, web pages, computing environments, and the like, can also implement the technology described herein.

Checkpoints or breakpoints can be used to verify that an application under test functions as expected. For example, a user can add a breakpoint to check if a particular object, text or a bitmap is present in the automation run. The breakpoints verify that during the course of test execution, the actual application behavior or state is consistent with the expected application behavior or state. The breakpoints can enable a user to verify various aspects of an application under test, such as: the properties of an object, data within a table, records within a database, a bitmap image, or the text on an application screen.

Breakpoints can instruct a test application, such as QTP, to pause a running or executing session at a predetermined place in a test or function. The test can be paused to enable a user to, for example, examine the effects of the run up to the breakpoint, make any desired changes, continue running the test or function library from the breakpoint, suspend a run session and inspect the state of the application, and/or mark a point from which to begin stepping through a test or function library. In one aspect, the breakpoints can be temporarily enabled or disabled.

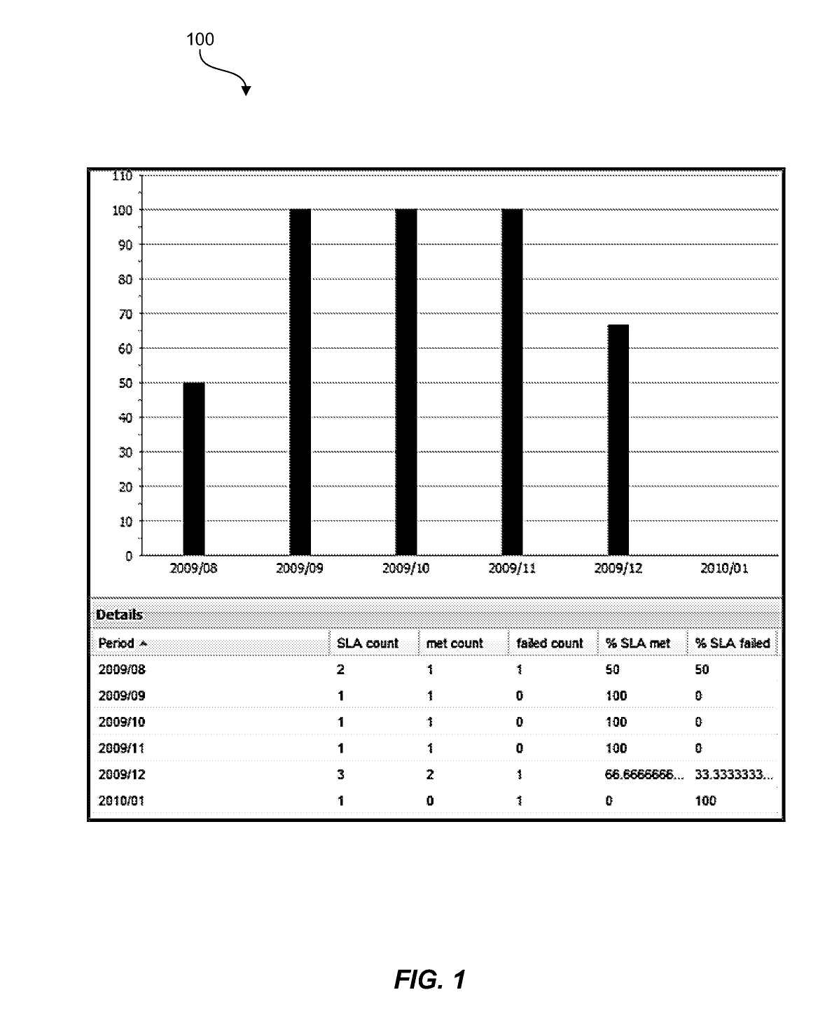

Referring to FIG. 1, an example dashboard object 100 is illustrated. The dashboard object can be a web object in a web page or a standalone object or integrated application object. As described above, dashboard objects can take a variety of forms, shapes, and configurations. The dashboard object can represent historical and/or real time data, and can retrieve data for display from static, dynamic, or streaming data sources. The example dashboard object in FIG. 1 illustrates a bar chart with additional details in a spreadsheet below the bar chart. The dashboard object can be configured to obtain data from a data source, such as a database, data warehouse, and the like and to provide a representation of the data in the dashboard object. For example, a bar chart dashboard object as shown may depict a number of met service level agreements (SLAs) over a defined time period as compared with a number of total SLAs in the period.

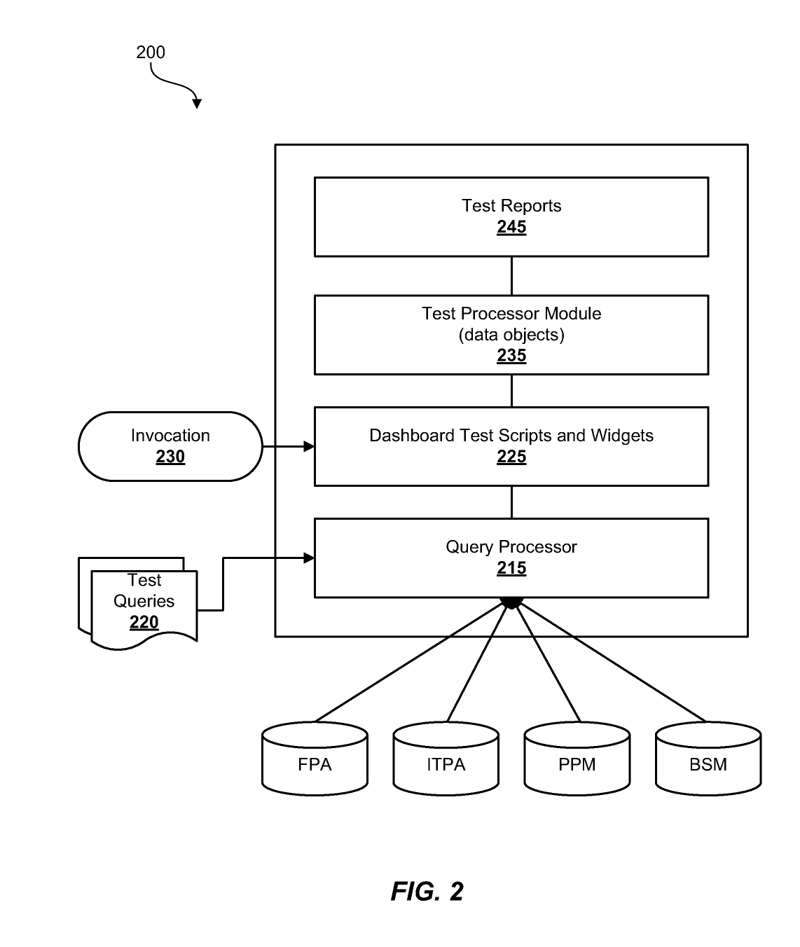

When implementing a dashboard object, either for public or internal use, businesses desire that the dashboard object provide an accurate representation of the underlying data. Referring to FIG. 2, a framework 200 is shown for testing and/or validating the accuracy of the dashboard object data representation.

The test assist framework 200 can be in communication with various data sources, such as, for example, a Financial Planning and Analysis (FPA) database 210, an Information Technology Performance Analytics (ITPA) database 211, a Project and Portfolio Management (PPM) database 212, and a Business Service Management (BSM) database 213. Any desired number and type of database or other data source can be used to provide data for a dashboard object. At least one of the FPA, ITPA, PPM, and BSM databases in this example is providing a basis for data representations in a dashboard object.

The test assist framework 200 can also include various modules, such as a query processor 215, dashboard test widgets 225, test processor(s) 235, and test assist reports 245.

The query processor 215 has capabilities to execute unit and integration test SQL (Structured Query Language) queries against various types of databases, such as, for example, MSSQL (Microsoft SQL) and Oracle databases. The query processor can substitute parameters that are entered during execution time. For example, test queries 220 can be entered and/or executed while a dashboard object on a web page is loading and/or running The query processor can use the results of one query to perform a subsequent query. As a result, the query processor module can allow a QA manager to automate the time consuming and error prone manual process of running a sequence of SQL queries and substituting parameters using results of the previous runs.

The dashboard test widgets 225 can be used to process the data or results returned by the query processor 225 and produce summary data and graphs that represent what the user can expect to see on the dashboards displayed in the product. The dashboard test widgets module can automate the manual calculation of the expected results based on the contents of the test database (e.g., at least one of the FPA, ITPA, PPM, and BSM databases in this example). The dashboard test widgets module can be configured to accurately re-generate the expected results on the fly against a new set of test data.

The test processor module 235 may use out-of-box features of VBScript. For example, the test processor can support invocation 230 and execution of test scripts via operating system commands, a scheduled task, a QTP script, and the like. The data objects constructed by the test scripts can be used in a breakpoint of a recorded QTP test to validate properties of User Interface

(UI) or graphical objects.

The test assist reports module 245 can produce validation reports that can be accessed locally or via a web-browser. Since the validation reports represent what the user can expect to see on web-based dashboards, the validation reports can be used by a user to validate the dashboards in a shorter time and with a higher accuracy. Use of these test assist reports may produce a greater than 70 percent savings in test execution time.

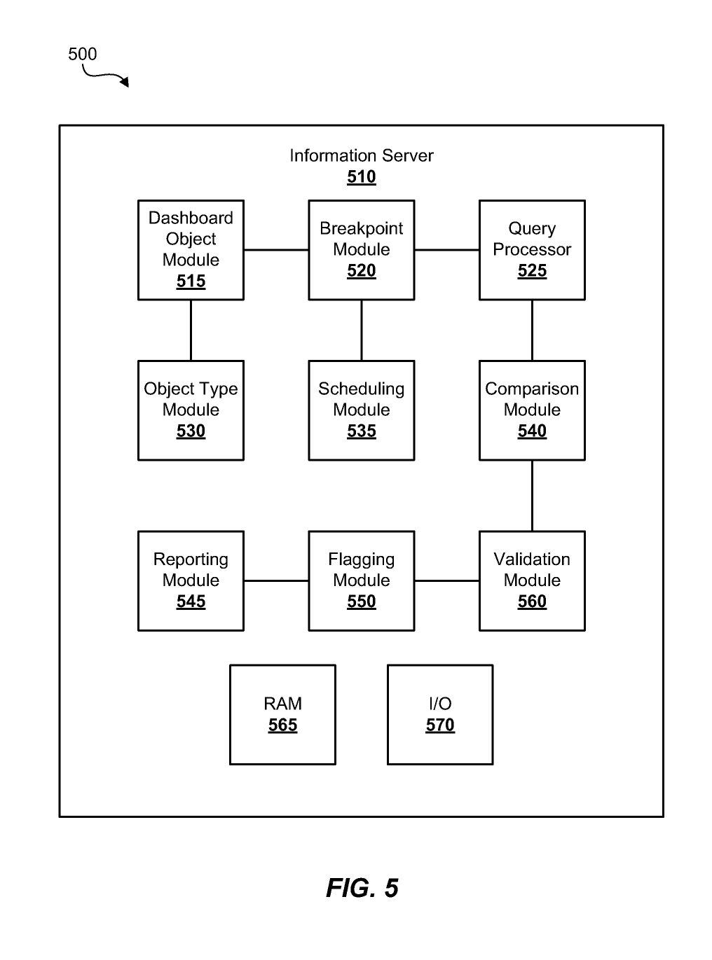

The system can also include a comparison module which can perform the comparison of the dashboard data to the underlying data based on a predefined set of rules. For example, the data shown in the dashboard object can be compared with the underlying data and can be validated when the compared data is the same or within a predetermined threshold difference. The comparison module is further described below in relation to FIG. 5.

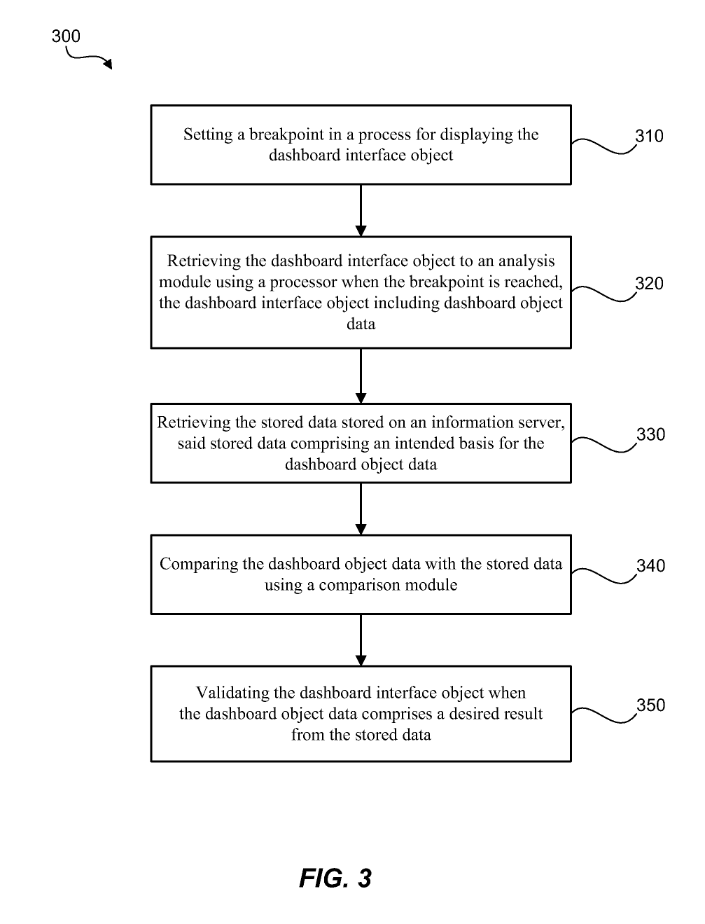

Referring to FIG. 3, a method 300 is shown for validating a dashboard interface object with stored data. The method includes setting 310 a breakpoint in a process for displaying the dashboard interface object. The dashboard interface object can be retrieved 320 to an analysis module using a processor when the breakpoint is reached. The dashboard interface object can include dashboard object data. In one aspect, dashboard object data may comprise a summary of the stored data. The stored data can be stored on an information server and can be an intended basis for the dashboard object data. The stored data can be retrieved 330 and can be compared 340 with the dashboard object data using a comparison module. The dashboard interface object can be validated 350 when the dashboard object data is a desired result from the stored data.

In one aspect, the method can include identifying a type of the dashboard object and loading a configuration file associated with the type of dashboard object. For example, a dashboard object may have an associated type of “bar chart”, “pie chart”, or some other designated type. The dashboard object type can be used to correctly interpret the data represented in the dashboard object. For example, if a dashboard object type is a pie chart and a data representation in the pie chart is designated as 33% of the pie chart, the underlying data from a database can be analyzed. If the underlying data indicates that six widgets were to be produced and two of those widgets were not produced, then if the 33% of the pie chart data representation corresponds to the two unproduced widgets the dashboard data representation is accurate and can be validated. If, however, the three widgets were not produced, then the dashboard object data will may be validated for not sufficiently corresponding to the underlying data.

The dashboard interface object can be invoked by a variety of methods. The invocation can be the start of a process which includes the breakpoint used in validating the dashboard object. In one example, invoking the dashboard interface object can be performed by input of a user command. In another example, the dashboard interface object can be invoked as part of a scheduled task. As another example, the dashboard interface object can be invoked using a test step in a functional or regression testing analysis.

The method may also include flagging the dashboard interface object when the dashboard object data comprises a different result from the stored data. In other words, if the dashboard object data does not correspond, at least within a predetermined value, to the stored data, the dashboard interface object can be flagged to indicate to a user that the data is not being correctly represented. The user can then analyze the dashboard object to determine the cause of the inconsistency in the data.

In one aspect, no action is taken when a dashboard interface object has been flagged, other than to wait for a user to address the issue. In another aspect, the method can include notifying a user when the dashboard interface object is flagged. For example, a popup window can be displayed to the user on a user display device. In another example where the user is not present at a computer or processor testing the dashboard object, a notification can be sent to the user via e-mail, text message, voice message, instant message, or any other suitable form of notification. The notification can include information about the result of the comparison, such as the identification of the dashboard object, the specific data that was inconsistent, the actual underlying data, when the comparison was made, when the underlying stored data was obtained, version information for the dashboard object, or any other desirable and/or useful information. A notification module can be used to provide the notifications to the user. User notification can also be performed, for example, when the dashboard object data is an accurate representation or manipulation of the underlying stored data.

In a further example, a different result may occur when the dashboard object data is based on data other than the stored data. Using the test framework 200 shown in FIG. 2 for illustration purposes, the different result may occur, for example, when the dashboard object is intended to represent data from the FPA database 210 but instead represents data from the ITPA database 211. The different result may occur when the dashboard object data differs from the stored data beyond a predetermined threshold. For example, if the dashboard object data indicates that 67% of widgets were shipped on time and the stored data indicates that 66.66667 widgets were shipped on time, the difference can be within a threshold and the data can be validated. However, if the dashboard object data indicated that 47% of widgets were shipped on time as compared with the stored data indication that 66.66667 widgets were shipped on time, then the difference may be outside of a threshold and the data will not be validated. In this case, the dashboard object would be flagged and a notification may be sent to a user.

As another example, a different result may occur when the dashboard interface object includes an amount of dashboard object data different than a predetermined amount. Using a pie chart example, the dashboard object pie chart may represent fewer or greater pie slices than are actually supported by the underlying data. Such an inconsistency would produce the different result. As another example, the different result may occur when the dashboard interface object represents the dashboard object data in a format different from a predetermined representation format. If the dashboard object is configured to represent the dashboard object data as a pie chart and the data is being represented as a bar chart, the dashboard object can be flagged. Likewise, if the dashboard object is configured to represent the dashboard object data as actual numbers and the dashboard object data is being represented as percentages, the dashboard object can be flagged.

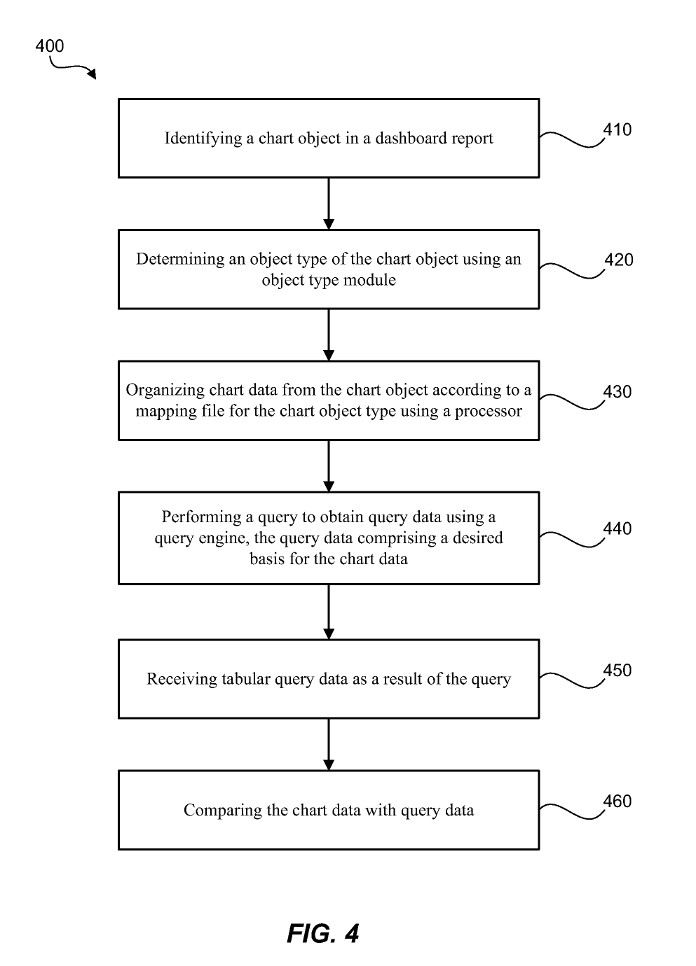

Referring to FIG. 4, a method 400 is shown for validating an object with data in accordance with an embodiment. The method includes identifying 410 a chart object (e.g., a dashboard object) in a dashboard report. The object type of the chart object can be determined 420 using an object type module. Chart data from the chart object can be organized 430 according to a mapping file for the chart object type using a processor. For example, the mapping file can include information as to how data is mapped from a data source to the chart object in order to understand how the data is being used and/or what the data means. In some dashboard objects, the data may be mapped from the underlying data source into a different arrangement in the dashboard object. The mapping file can be used both to map the data from the data source to the dashboard object, and to organize the dashboard object data for comparison with the stored data to validate the dashboard object data.

The method can also include performing 440 a query to obtain query data using a query engine. The query data may comprise a desired or intended basis for the chart data. In other words, the query engine can retrieve the stored data from the data source and compare the stored data with chart data from a chart configured to retrieve and display a representation of the stored data. In one aspect, the stored data can be received 450 as tabular query data as a result of the query. The mapping file can be used to organize the chart data into a tabular format which corresponds with the resultant tabular query data. The chart data can then be compared 460 with the query data. The chart object, and/or the chart data represented by the chart object, can be validated when a sufficient correspondence of the data is found as a result of the comparison.

Referring to FIG. 5, an example system 500 for validating a dashboard interface object with data is shown in accordance with an example. The system includes an information server 510 for storing and/or supplying data for the dashboard interface object. For example, the information server can store and/or retrieve data to and from various databases stored on computer readable media in electronic communication with the information server.

A dashboard object module 515 can be on the information server 510 and can represent dashboard object data using dashboard interface objects. The dashboard object module can use a mapping file, such as that described above regarding FIG. 4, to organize, format, interpret, modify, or otherwise map data from a data source for display by the dashboard interface object.

A breakpoint module 520 can be used to set a breakpoint in a process for displaying the dashboard interface object. At the breakpoint, the dashboard object and/or dashboard object data can be retrieved. A query processor 525 can perform a query to obtain the data from the information server. In other words, the query processor can obtain data via the information server from a data store in communication with the information server.

The system can include an object type module 530. The object type module can determine an object type of the dashboard interface object. The object type module can be further configured to organize the dashboard interface data from the dashboard interface object according to a mapping file for the object type using a processor, as has been described above. The object type module in determining a type of dashboard object can also identify an identification of the dashboard object. The identification of the dashboard object can be correlated with a particular data store or a set of data from within the data store to enable the query processor to obtain the data from which the dashboard object is intended to form the dashboard data representation. In another example, the query processor can query the dashboard object or dashboard object module to identify an identification of the dashboard object and/or to identify a data source or data set which is intended to be the basis of the dashboard data representation.

The system 500 can include a scheduling module 535. The scheduling module can invoke the dashboard interface object as part of a scheduled task. The scheduling module can be integral with an invocation module (not shown). The invocation module can use the scheduling module to schedule tasks and/or to invoke the dashboard object according to a scheduled task. The invocation module can also be used by a user via a graphical UI component of the invocation module to invoke the dashboard interface object by a user command. In another aspect, the invocation module can invoke the dashboard interface object using a test step in a functional or regression testing analysis of the dashboard interface object. The query processor can be configured to obtain the basis or stored data when the dashboard object data is obtained after the invocation module causes an invocation of the dashboard object, at which point a breakpoint is reached for obtaining the dashboard object data.

The system 500 can include a comparison module 540. The comparison module can compare the dashboard object data with the data obtained from/via the information server. The comparison module can thus be in communication with the query processor 525 and the dashboard object module 515 to obtain the dashboard object data and the stored data upon which the dashboard object data is desired to be based. In some instances, the dashboard object data may comprise manipulated data manipulated from the stored data. In such an example, the comparison module can perform a regression of the manipulation to obtain the pre-manipulation data used in the dashboard object. The comparison module can thus modify the data as indicated by the mapping file from the object type module 530 in order to make valid and accurate comparisons of data. The comparison module can compare the dashboard object data with the stored data to determine whether the dashboard object data and the stored data are the same, or whether the dashboard object data and the stored data have at least a predetermined minimal correspondence.

The system 500 can include a validation module 560. The validation module can be in communication with the comparison module 540 to obtain the compared data or a result of the comparison of data. The validation module can be used to validate the dashboard interface object when the dashboard object data is a desired result from the stored data. In other words, when the dashboard object data and the stored data are the same, or when the dashboard object data and the stored data have at least a predetermined minimal correspondence, the validation module can validate the dashboard object or dashboard object data. The desired result from the stored data can be an accurate representation of the stored data or can be an accurate manipulation of the stored data. The validation module can also be configured to not validate the dashboard object or dashboard object data when the dashboard object data is not a desired result from the stored data.

The system 500 can include a flagging module 550 in communication with the validation module 560. The flagging module can be used for flagging the dashboard interface object when the dashboard object data comprises a different result from the stored data. In other words, the flagging module can flag the dashboard interface object when the dashboard object data is not the desired result from the stored data. The flagging module can mark the dashboard object or the test of the dashboard object for subsequent review by a user. In one aspect, the system can be used to test and validate multiple dashboard objects. In such an example, the flagging module can maintain a list of flagged dashboard objects or tests for the user to review.

A reporting module 545 can be in communication with the flagging module 550. The reporting module can be used for preparing a report of the dashboard object validation tests, which report may be accessible locally or over a network link. The reporting module can use an extended mark-up language (XML) schema in producing the report. The test result report can indicate whether a test passed or failed (i.e., whether the dashboard object (data) was validated or not validated), show error messages, and may provide supporting information to enable the user to determine an underlying cause of a failure. The reporting module can enable export of the test results into HTML, text, word processing files, PDF report formats, or any other desired report format. The reports can include images and/or screen shots for use in analyzing the report.

The reporting module 545 can also provide reports or notifications to the user when the dashboard interface object is flagged. As described above, the user notifications may comprise any of a variety of notification methods, including pop-up windows, email, text message, instant message, voice message, and so forth. To facilitate the various notifications, the reporting module can maintain user contact information, including, for example, an email address, a cell phone number, a user instant messaging identification, a voice mailbox number, and so forth. The reporting module can enable a user to select a desired method of notification and to input the user contact information for notifying the user via the selected method of notification.

The system 500 can further include processors, random access memory (RAM) 565, I/O buses 570, and other components for use by the various modules in performing the described functionality of the modules. In one aspect, the system the memory can include program instructions that when executed by the processor function as the modules described above. The system 500 can manage exception handling using recovery scenarios. In other words, the system can continue running tests on the dashboard objects even if an unexpected failure occurs. For example, if a dashboard object or the testing framework crashes, the system can attempt to restart the dashboard object or the testing framework and continue with the rest of the test cases from that point.

The system 500 can also support data-driven testing. In other words, data or results of dashboard object validation can be output to a data table for reuse elsewhere.

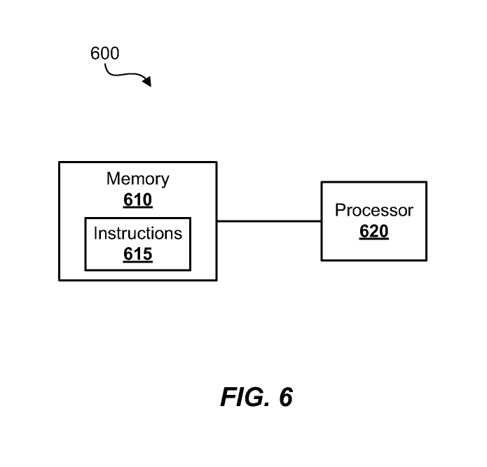

Referring to FIG. 6, a system 600 and/or method can be implemented using a memory 610, processor 620, and/or computer readable medium. For example, an article of manufacture can include a memory or computer usable storage medium having computer readable program code or instructions 615 embodied therein for validating an object and comprising computer readable program code capable of performing the operations of the methods described. In another example, the memory can include portable memory containing installation files from which software can be installed or remote memory from which installation filed can be downloaded. Also, program instructions stored in the memory can be embodied in installation files or installed files. The technology described in the foregoing examples can be used to improve a product quality process and as a result can accelerate a development cycle. The technology can be used to automate the time consuming and error-prone testing process for dashboard validation. The reports can provide expected results useful to visually compare against all dashboard content. The technology can provide easy pass/fail recognition at test execution time, resulting in improved accuracy of testing. As indicated above, the technology can result in greater than 70% savings in test execution time over prior systems and methods. The technology can include an application programming interface (API) that can be integrated with existing test tools to provide further time-saving and quality testing. The data objects constructed by the test scripts can be used in a checkpoint of a recorded test to validate properties of User Interface or graphical objects.

The methods and systems of certain embodiments may be implemented in hardware, software, firmware, or combinations thereof. In one embodiment, the method can be executed by software or firmware that is stored in a memory and that is executed by a suitable instruction execution system. If implemented in hardware, as in an alternative embodiment, the method can be implemented with any suitable technology that is well known in the art.

Also within the scope of an embodiment is the implementation of a program or code that can be stored in a non-transitory machine-readable medium to permit a computer to perform any of the methods described above. For example, implementation can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain program instruction and data for use by or in connection with the instruction execution system such as a processor. Computer readable media can comprise any one of many physical media such as, for example, electronic, magnetic, optical, electromagnetic, or semiconductor media. More specific examples of suitable computer-readable media include, but are not limited to, a magnetic computer diskette such as floppy diskettes or hard drives, a random access memory (RAM), a read-only memory (ROM), an erasable programmable read-only memory, or a portable device such as a compact disc (CD), thumb drive, or a digital video disc (DVD).

Various techniques, or certain aspects or portions thereof, may take the form of program code (i.e., instructions) embodied in tangible media, such as floppy diskettes, CD-ROMs, DVDs, hard drives, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Some of the functional units described in this specification have been labeled as modules, in order to more particularly emphasize their implementation independence. The various modules, engines, tools, or modules discussed herein may be, for example, software, firmware, commands, data files, programs, code, instructions, or the like, and may also include suitable mechanisms. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions. The modules can also be a combination of hardware and software. In an example configuration, the hardware can be a processor and memory while the software can be instructions stored in the memory. While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

1. A processor implemented object validation method, comprising:
obtaining a dashboard interface object, the dashboard interface object including dashboard object data;
comparing the dashboard object data with stored data representing an intended basis for the dashboard object data; and
validating the dashboard interface object when the dashboard object data comprises a desired result based on the comparing.

2. A method as in claim 1, further comprising identifying a type of the dashboard object and loading a configuration file associated with the type of dashboard object.

3. A method as in claim 1, further comprising invoking the dashboard interface object in response to a user command.

4. A method as in claim 1, further comprising at least one of invoking the dashboard interface object as part of a scheduled task and invoking the dashboard interface object using a test step in a functional or regression testing analysis.

5. A method as in claim 1, further comprising a processor implemented action of displaying validation on a display device when the dashboard object data comprises the desired result.

6. A method as in claim 1, wherein the dashboard object data comprises a summary of the stored data.

7. A method as in claim 1, further comprising flagging the dashboard interface object when the dashboard object data comprises a different result from the stored data.

8. A method as in claim 7, further comprising a processor implemented action of notifying a user when the dashboard interface object is flagged.

9. A method as in claim 7, wherein the different result occurs when the dashboard object data is based on data other than the stored data, when the dashboard object data differs from the stored data beyond a predetermined threshold, when the dashboard interface object includes an amount of dashboard object data different than a predetermined amount, or when the dashboard interface object represents the dashboard object data in a format different from a predetermined representation format.

10. A computer readable medium having program instructions for validating a dashboard interface object with data that when executed by the processor function as a dashboard object module, a query processor, a comparison module, and a validation module, wherein:
the dashboard object module is operable to represent dashboard object data using the dashboard interface object;
the query processor is operable to a query to obtain the data from the information server;
the comparison module is operable to compare the dashboard object data with the data from the information server, upon which the dashboard object data is desired to be based; and
the validation module is operable to validate the dashboard interface object when the dashboard object data is a desired result as compared to the stored data.

11. A medium as in claim 10, wherein the memory further includes program instructions that when executed by the processor function as a flagging module operable to flag the dashboard interface object when the dashboard object data comprises a different result from the stored data

12. A medium as in claim 10, wherein the memory further includes program instructions that when executed by the processor function as a reporting module operable to notify a user when the dashboard interface object is flagged.

13. A medium as in claim 10, wherein the memory further includes program instructions that when executed by the processor function as a scheduling module operable to invoke the dashboard interface object as part of a scheduled task.

14. A medium as in claim 10, wherein the memory further includes program instructions that when executed by the processor function as an object type module operable to determine an object type of the dashboard interface object and to organize the dashboard interface data from the dashboard interface object according to a mapping file for the object type using a processor.

15. A system for validating an object with data, comprising a processor and a memory, the memory including program instructions capable of performing the operations of:
identifying a chart object in a dashboard report;
determining an object type of the chart object using an object type module;
organizing chart data from the chart object according to a mapping file for the chart object type using a processor;
performing a query to obtain query data using a query engine, the query data comprising a desired basis for the chart data; and
comparing the chart data with the query data.
